(19) United States
(12) Patent Application Publication
(10) Pub. No.: US 2012/0030156 A1
(43) Pub. Date: Feb. 2, 2012

(54) COMPUTER-IMPLEMENTED METHOD, CLINICAL DECISION SUPPORT SYSTEM, AND COMPUTER-READABLE NON-TRANSITORY STORAGE MEDIUM FOR CREATING A CARE PLAN

(75) Inventors: ROB THEODORUS UDINK, BEST (NL); MARIANA NIKOLOVA-SIMONS, BOLTON, MA (US); ALEKSANDRA TESANOVIC, EINDHOVEN (NL); WILHELMUS JOHANNES JOSEPH STUT, EINDHOVEN (NL)

(73) Assignee: KONINKLIJKE PHILIPS ELECTRONICS, N.V., EINDHOVEN (NL)

(21) Appl. No.: 13/190,592

(22) Filed: Jul. 26, 2011

Related U.S. Application Data
(60) Provisional application No. 61/368,331, filed on Jul. 28, 2010.

(51) Int. Cl. G06F 15/18; G06N 5/02; G06N 5/00

(52) U.S. Cl. 706/12; 706/45; 706/47

(57) ABSTRACT

A computer-implemented method for creating a care plan for a patient, the method comprising the steps of (a) receiving an intervention goal, (b) creating a behavioral determinants list using the intervention goal, (c) assigning a ranking to each behavioral determinant in the list of behavioral determinates using patient data descriptive of the patient, (d) receiving a subset of the behavioral determinant list, wherein the subset is determined by using the ranking of each behavioral determinant in the list of behavioral determinates; and (f) creating the care plan using the subset.

### CROSS-REFERENCE TO RELATED APPLICATIONS

This patent application claims the priority benefit under 35 U.S.C. §119(e) of U.S. Provisional Application No. 61/368,331, filed on Jul. 28, 2010, the contents of which are herein incorporated by reference.

### BACKGROUND OF THE INVENTION

1. Field of the Invention

The invention relates to care plans for remote patient management systems, in particular to creating a care plan to achieve an interventional goal.

2. Description of the Related Art

Behavioral change is an important aspect in the management of chronic conditions like Heart Failure, Chronic obstructive pulmonary disease, or diabetes. Behavioral determinants are the starting point of behavioral interventions to achieve the behavioral change.

Patient non-compliance decreases the efficacy of pharmacological and non-pharmacological therapy and exposes the patient to clinical destabilization, which can lead to exacerbating disease symptoms. Evidence from clinical trials and validated insights show that the most commonly identified cause of disease worsening, e.g. HF decompensation, is non-compliance with medication, low sodium diet, fluid restriction and physical activity. Non-compliance is the precipitating factor of exacerbation, leading to poor clinical outcomes.

### SUMMARY OF THE INVENTION

Structured approaches to identify the determinants that should be addressed in behavioral interventions are described in text books and educational material for medical professionals. However:

a) applying this knowledge in practice is a complex task: there are no systems offering a list of possible determinants to the professional, e.g., the relevant personal characteristics of the patients and their relation to specific behavioral goals; there are no systems offering a list of possible interventions for modifying (a set of) determinants;

b) the risk overseeing or not taking into account specific characteristics of a patient is quite high and could result in selecting the wrong determinates and consequently applying a less effective intervention; and

c) medical professionals have not enough time to keep up to date with newest evidence becoming available regularly.

Therefore, success is often based on the level of experience of the care professional. Embodiments of the invention may address these difficulties and others with a clinical decision support system which provides the care professional with an up-to-date overview of determinants relevant for reaching behavioral goals based on evidence from clinical trials and consumer studies. Various embodiments of the invention may:

a) provide the determinants specific for a patient, based that patient's health at the right moment in time to allow the professional to make the right decision;

b) educe the (administrative) effort needed to apply a structural determinant selection process;

c) optimize the workflow or the care professional; Provide a structured way to professionals to identify the determinants (examples of determinants are knowledge, attitude, perceived barriers, self efficacy);

d) tag literature for evidence and use that information for weighing determinants;

e) make an explicit link between determinant and chance of success in reaching goals;

f) merge different therapy goals with associated determinants into a single advice in which determinants to address;

g) instantiate of a set of determinants for a patient based on historical data (function, trend, not latest value);

h) create audit trails of the current practice to provided evidence for process improvement; and

i) dentify improvements based on historical data.

Embodiments may achieve some or all of these goals by:

a) providing a structured way to professionals to identify the determinants;

b) tagging of literature for evidence and use that info for weighing determinants

c) making an explicit link between determinant and chance of success in reaching goals;

d) merging different therapy goals with associated determinants into a single advice on which determinants to address;

e) instantiation of a set of determinants for a patient based on historical data (function, trend, not latest value);

f) create audit trails of the current practice to provided evidence for process improvement; and

g) effect analyzer: identifying improvements based on historical data.

A ‘remote patient management system’ as used herein is a system for remotely administering a care plan. A ‘care plan’ as used herein is a day-to-day plan for managing a disease or health condition. A ‘content element’ as used herein is content which may be provided to a patient and which may be integrated into a care plan for the patient. For instance a remote patient management system may present content elements for educating, motivating, or assessing a patient. Examples of these content elements include, but are not limited to: text messages, audio messages, or video messages, educational games, educational video games, questionnaires, surveys, quizzes, interactive videos. The term content element encompasses both multimedia presented to a patient and to media with which the patient interacts.

Content elements may be provided either by a hospital or an outpatient clinic or a disease management organization or a remote patient management system.

A ‘home infrastructure device’ as used herein is a device adapted for delivering the content elements to the patient. The home infrastructure device comprises at least one diagnostic medical device for measuring a value of a patient's vital sign.

The term ‘vital sign’ as used herein refers to are any physical property of the patient which may be measured. Examples of vital signs include, but are not limited to: weight, blood sugar level, blood pressure, pulse/heart rate, SpO2, and bio-impedance.

A ‘display’ as used herein is an electronic device adapted for graphically displaying text, images, multimedia clips, video, and other audio-visual content. Examples of a display include, but are not limited to: a computer monitor, the screen of a cellular telephone, and a television.

A ‘computer-readable storage medium’ as used herein is any storage medium which may store instructions which are executable by a processor of a computing device. The computer-readable storage medium may be a computer-readable non-transitory storage medium. The computer-readable storage medium may also be a tangible computer readable medium. In some embodiments, a computer-readable storage medium may also be able to store data which is able to be accessed by the processor of the computing device. An example of a computer-readable storage medium include, but are not limited to: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example data may be retrieved over a modem, over the internet, or over a local area network.

Computer memory is an example of a computer-readable non-transitory storage medium. Computer memory is any memory which is directly accessible to a processor. Examples of computer memory include, but are not limited to: RAM memory, registers, and register files.

Computer storage is an example of a computer-readable non-transitory storage medium. Computer storage is any non-volatile computer-readable storage medium. Examples of computer storage include, but are not limited to: a hard disk drive, a USB thumb drive, a floppy drive, a smart card, a DVD, a CD-ROM, and a solid state hard drive. In some embodiments computer storage may also be computer memory or vice versa.

A ‘processor’ as used herein is an electronic component which is able to execute a program or machine executable instruction. References to the computing device comprising “a processor” should be interpreted as possibly containing more than one processor. The term computing device should also be interpreted to possibly refer to a collection or network of computing devices each comprising a processor. Many programs have their instructions performed by multiple processors that may be within the same computing device or which may even distributed across multiple computing device.

A ‘data base’ as used herein encompasses a data stored in a computer memory or computer storage that is stored in a organized fashion such that data of interest may be accessed using an indexing system or search function. Examples of data bases include, but are not limited to: a text file containing data, a folder in a file system containing a collection of data files, a spreadsheet containing data, and a relational database.

The invention provides for a computer-implemented method for creating a care plan for a patient. The method comprises the step of receiving an intervention goal. An ‘intervention goal’ as used herein is a goal of a medical intervention. An intervention goal may be for instance to reduce weight or to reduce sodium intake. The method further comprises the step of creating a behavioral determinants list using the intervention goal. A behavioral determinant is a psychological factor which affects the behavior of a patient. The intervention goal may be entered into a computer interface or a graphical user interface by a healthcare professional in some embodiments. In other embodiments the intervention goal is generated automatically from input by a remote patient management system.

Once the intervention goal is received the behavioral determinants list may be generated automatically. For instance for a particular intervention goal there may be a cross reference or listing in a database which references specific behavioral determinants which may then be used to create the behavioral determinants list. The method further comprises the step of assigning a ranking to each behavioral determinant in the list of behavioral determinants using patient data descriptive of the patient. The ranking may be numerical, a set of descriptive labels, or a graphical ranking which indicates which of the behavioral determinants in the list of the behavioral determinants is most relevant to a particular patient.

‘Patient data’ as used herein may have several different meanings Patient data may be part or comprise a patient's medical record. Patient data may also be data derived or obtained from a remote patient management system. Patient data may also be information which is supplied or entered by a healthcare professional in response to queries on a display or graphical user interface.

The method further comprises the step of receiving a subset of the behavioral determinant list. The subset is determined by using the ranking of each behavioral determinant in the list of behavioral determinants. In this step a subset of the behavioral determinants list is selected. This may be done automatically for instance using the ranking. If the subset is generated automatically then the rankings may be used to select determinants over a particular threshold or to select a predetermined number of determinants with the highest ranking. In some embodiments the ranking is simply displayed on a display or graphical user interface and the healthcare professional selects which of the behavioral determinants is a member of the subset. In still yet other embodiments a proposed subset of behavioral determinants is displayed for the healthcare professional. In this embodiment the subset is first displayed and then the healthcare professional may simply accept the subset or may edit it using a graphical user interface.

The method further comprises the step of creating the care plan using the subset. The care plan may for instance be compiled using a template or rules for creating a care plan. This computer-implemented method is advantageous because a personalized care plan is created for a patient which follows a rigorous method of determining behavioral determinants.

In another embodiment the care plan is created by generating a list of behavioral models using the subset of behavioral determinants. This may for instance be achieved by having a database of behavioral models. The behavioral models could be referenced to various behavioral determinants. The healthcare professional may then select a behavioral model which he or she believes to be appropriate for the particular patient. The care plan is further created by receiving a selection of at least one selected behavioral model from the list of behavioral models. The care plan is further created by compiling the care plan using a care plan template determined by the at least one selected behavioral model. The care plan template may for instance be a timeline with symbolic links representing multimedia or training content. During the compilation of the care plan the symbolic links to multimedia content may be resolved and content may be integrated into the care plan template. A care plant template are used herein encompasses a timeline or plan for creating a care plan.

In another embodiment the method further comprises receiving remote patient management system data. The step of receiving an intervention goal is performed by evaluating the remote patient management system data using a rule. In this embodiment the method is triggered by data which is received from a remote patient management system. For instance the patient's weight may be above a threshold or the patient may have gained or lost too much weight within a specified time. The remote patient management system data as used herein is data descriptive of (the health, behavior, knowledge, feelings, or other characteristics of) a patient which is generated by a remote patient management system. The remote patient management system data may be physical measurements or vital sign measurements of a patient in some embodiments. In other embodiments the remote patient management system data is a response to quizzes or questionnaires. In some embodiments the remote patient management system data is also a combination of vital sign or physical measurements from a patient and responses to a questionnaire.

In another embodiment the remote patient management system data comprises measurements of at least one vital sign from a patient.

In another embodiment the remote patient management system data comprises responses to a questionnaire. For instance a questionnaire may be used to ask a patient if he or she has performed some action or to query the patient about his or her opinion of their current health. For instance a questionnaire could enquire about the type of foods that a patient had recently eaten. As another example the remote patient management system could also ask the patient to give the amount of pain experienced by a numerical scale to estimate the effectiveness of treating chronic pain.

In another embodiment the method further comprises the step of displaying the behavioral determinant list graphically on a display before receiving the subset. The method further comprises displaying a graphical user interface at the same time as the behavioral determinant list which is adapted for triggering the display of medical evidence pertaining to each behavioral determinant. Essentially in this embodiment the medical evidence or data which is used to assign a ranking to each of the behavioral determinants is made available to the healthcare professional. This is advantageous because the healthcare professional is then able to use this data as part of his or her decision. The healthcare professional can evaluate the evidence for each of the behavioral determinants and determine if this evidence is relevant to this particular patient or not.

In another embodiment the method further comprises the step of displaying the ranked subset of determinants graphically on a display. The subset of behavioral determinants may be displayed graphically such that the ranking of the various behavioral determinants is clear to a healthcare professional. The subset is received from a graphical user interface of the display. This embodiment is advantageous because the ranking of each behavioral determinant is displayed to the healthcare professional and the healthcare professional is able to select which of the behavioral determinants are placed into the subset using a graphical user interface.

In another embodiment the patient data at least partially comprises remote patient management system data. The method further comprises requesting the remote patient management system data from a remote patient management system and the method further comprises receiving the remote patient management system data from the remote patient management system. In this embodiment it may be that there is not enough data to create the list of behavioral determinants. It may also be that if there is additional data or information from the patient, the number of behavioral determinants which are listed may be reduced. In this embodiment a remote patient management system is queried for data. The data which is returned by the query is then used to at least partially create the behavioral determinants list.

In another embodiment the method further comprises determining the type of remote patient management system data in order to reduce the length of the behavioral determinants list. For instance a preliminary behavioral determinants list could be constructed. The behavioral determinants list may have a listing for each behavioral determinant which lists data which is indicative of that particular behavioral determinant. This data can then be cross-referenced against the possible data which can be acquired by a remote patient management system. The remote patient management system can then be queried for this data. The method further comprises reducing the length of the behavioral determinants in accordance with the remote patient management system data. That is to say that the response to the query for remote patient management system data may provide data which eliminates some behavioral determinants on the list of behavioral determinants.

In another aspect the invention provides for a clinical decision support system comprising a processor and a computer-readable non-transitory storage medium. The computer-readable non-transitory storage medium contains instructions that cause the processor to perform the step of receiving an intervention goal. The instructions further cause the processor to perform the step of creating a behavioral determinants list using the intervention goal. The instructions further cause the processor to perform the step of assigning a ranking to each behavioral determinant in the list of behavioral determinants using patient data descriptive of the patient. The instructions further cause the processor to perform the step of receiving a subset of the behavioral determinants list. The subset may be determined by using the ranking of each behavioral determinant in the list of behavioral determinants. The instructions further cause the processor to perform the step of creating the care plan using the subset.

In another embodiment the care plan is created by the processor generating a list of behavioral models using the group of behavioral determinants. The care plan is further created by the processor receiving a selection of at least one selected behavioral model from the list of behavioral models. The care plan is further created by compiling the care plan using the care plan template determined by the at least one selected behavioral model.

In another embodiment the clinical decision support system further comprises a medical records database comprising at least a portion of the patient data. The processor further performs the step of requesting the patient data from the medical record database. The instructions further cause the processor to perform the step of receiving the patient data from the medical record database.

In another embodiment the clinical decision support system further comprises a historical evidence generator. The historical evidence generator comprises computer executable code for statistically analyzing the medical record database for correlations between the intervention goal and behavioral determinants. The clinical decision support system further comprises an evidence database. The historical evidence generator further comprises computer executable code for entering correlations between the intervention goal and behavioral determinants into the evidence database. The processor further performs the step comprising extracting the behavioral determinants list from the evidence database. This embodiment is particularly advantageous because historical or medical data is data mined or statistically analyzed to correlate the intervention goals with behavioral determinants.

The clinical decision support system comprises a tagger module comprising computer executable code for extracting correlations between the intervention goals and behavioral determinants from publications. This is advantageous because data from publications may be entered into the evidence database.

In another embodiment the tagger module uses natural language processing to extract correlations between intervention goals and behavioral determinants from publications. In this embodiment a document or a publication may be parsed in such a way that the correlations between the intervention goals and the behavioral determinants can be determined automatically. In some embodiments the correlations may be determined automatically but may be first approved by a healthcare professional before they are entered into the evidence database.

In another aspect the invention provides for a computer-readable non-transitory storage medium containing instructions that when executed by a processor of a clinical decision support system cause the processor to perform the step of receiving an intervention goal. Instructions further cause the processor to create a behavioral determinant list using the intervention goal. Instructions further cause the processor to assign a ranking to each behavioral determinant in the list of behavioral determinants using data descriptive of the patient. The instructions further cause the processor to receive a subset of the behavioral determinant list. The subset may be determined by using the ranking of each behavioral determinant in the list of behavioral determinants. The instructions further cause the processor to perform the step of creating the care plan using the subset.

In another embodiment the care plan is created by generating a list of behavioral models using the group of behavioral determinants. The care plan is further created by receiving a selection of at least one selected behavioral model from the list of behavioral models. The care plan is further created by compiling the care plan using a care plan template determined by the at least one selected behavioral model.

In another embodiment the instructions further cause the processor to perform the step of receiving remote patient management system data. The instructions further cause the processor to perform the step of evaluating the remote patient management system data using a rule to generate an intervention goal.

In another embodiment the instructions further cause the processor to perform the step of displaying the behavioral determinant list graphically on a display before receiving the subset. The instructions further cause the processor to perform the step of displaying a graphical user interface at the same time as the behavioral determinant list. The graphical user interface is adapted for triggering the display of medical evidence pertaining to each behavioral determinant.

In another embodiment the instructions further cause the processor to perform the step of displaying the ranked subset of determinants graphically on a display. The subset is received from a graphical user interface on the display

### BRIEF DESCRIPTION OF THE DRAWING

In the following preferred embodiments of the invention will be described, by way of example only, and with reference to the drawings in which:

FIG. 1 illustrates an embodiment of a method according to the invention;

FIG. 2 illustrates a further embodiment of a method according to the invention;

FIG. 3 shows a table of examples of behavioral models addressing specific behavioral determinants;

FIG. 4 shows a further embodiment of a method according to an embodiment of the invention;

FIG. 5 illustrates a further embodiment of a method according to the invention;

FIG. 6 shows a display of the determinants as may be displayed on a graphical user interface according to an embodiment of the invention;

FIG. 7 shows a further of the determinants as may be displayed on a graphical user interface according to a further embodiment of the invention;

FIG. 8 shows a further of the determinants as may be displayed on a graphical user interface according to a further embodiment of the invention;

FIG. 9 shows a functional diagram of a clinical decision support system according to an embodiment of the invention; and

FIG. 10 shows a functional diagram of a clinical decision support system according to a further embodiment of the invention.

### DETAILED DESCRIPTION OF THE EMBODIMENTS

Like numbered elements in these Figures are either equivalent elements or perform the same function. Elements which have been discussed previously will not necessarily be discussed in later Figures if the function is equivalent.

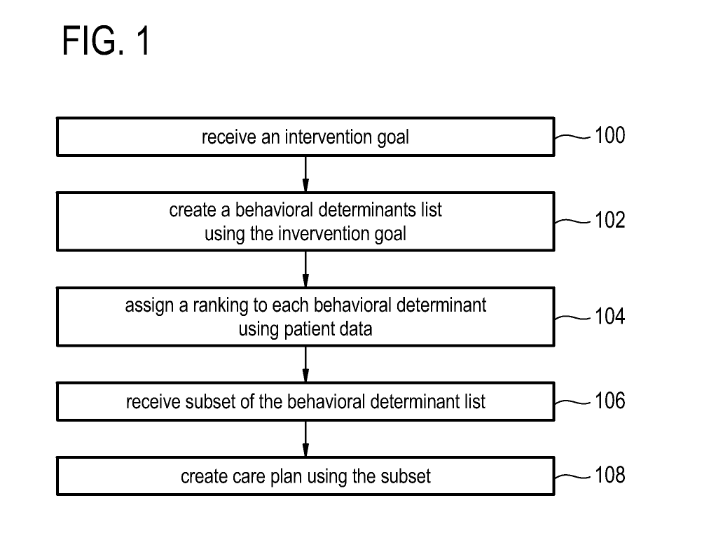

FIG. 1 illustrates an embodiment of a method according to the invention. The method shown in FIG. 1 may be implemented in some embodiments as a computer-implemented method. In some embodiments the method shown in FIG. 1 may also be performed by instructions on a computer-readable non-transitory storage medium. In step 100 an intervention goal is received. In step 102 a behavioral determinants list is created using or in accordance with the intervention goal. In step 104 a ranking is assigned to each behavioral determinant using patient data. In step 106 a subset of the behavioral determinant list is received. In some embodiments the subset is generated automatically using the ranking. In other embodiments the behavioral determinant list is received from a healthcare professional. In step 108 a care plan is created using the subset.

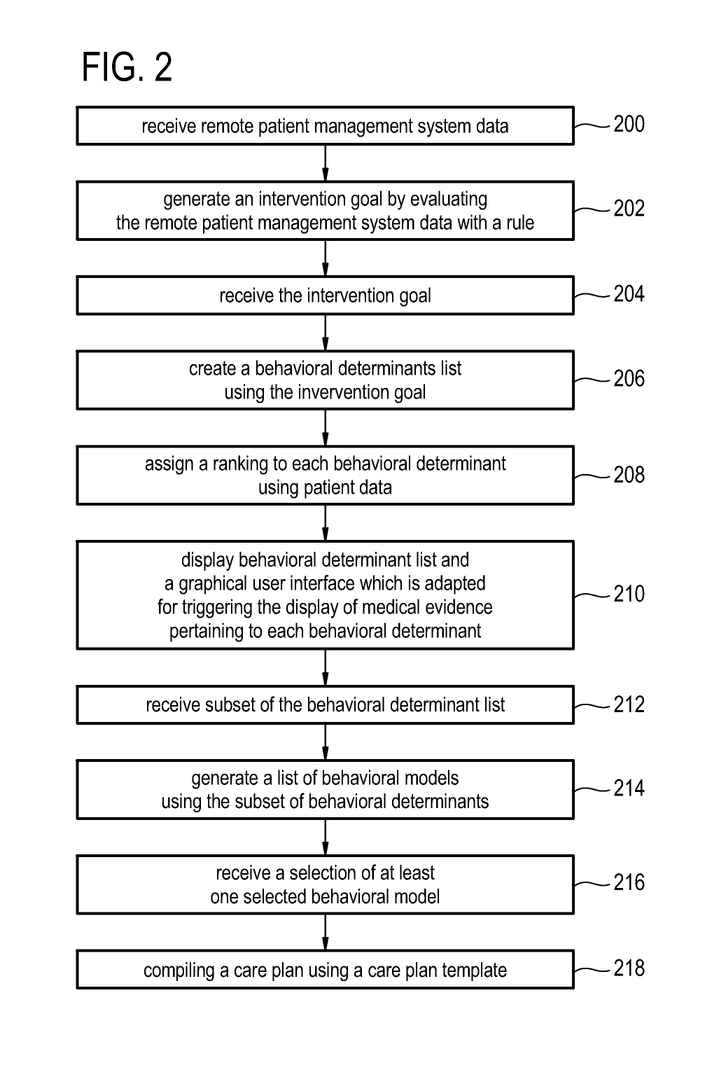

FIG. 2 shows a further embodiment of a method according to the invention. As with FIG. 1, FIG. 2 may be implemented as a computer-implemented method. The method shown in FIG. 2 may also be implemented by instructions contained on a computer-readable non-transitory storage medium. In step 200 remote patient management system data is received. In step 202 an intervention goal is generated by evaluating the remote patient management system data with a rule. The remote patient management system data is data acquired or received by a remote patient management system. The remote patient management system data may comprise vital sign or other physical measurements of the patient or it may contain responses to surveys presented to the patient.

In step 204 the intervention goal is received. In step 206 a behavioral determinants list is created using the intervention goal. In step 208 a ranking is assigned to each behavioral determinant using patient data. In step 210 the behavioral determinant list is displayed along with a graphical user interface which is adapted for triggering the display of medical evidence pertaining to each behavioral determinant. A healthcare professional can use the graphical user interface to explore the medical evidence which was used to generate the behavioral determinant list. In step 212 the subset of the behavioral determinant list is received. The healthcare professional may simply select which of the behavioral determinants to include in the subset. In this case the subset is received from the graphical user interface.

In step 214 a list of behavioral models is generated using or in accordance with the subset of behavioral determinants. In step 216 a selection of at least one behavioral model is received. Finally in step 218 a care plan is compiled using a care plan template. A care plan template is simply a set of rules or instructions on how to create a care plan that is personalized for a particular patient. The care plan template may typically include a timeline along with symbolic links to multimedia or other media or content information which may be integrated into the care plan.

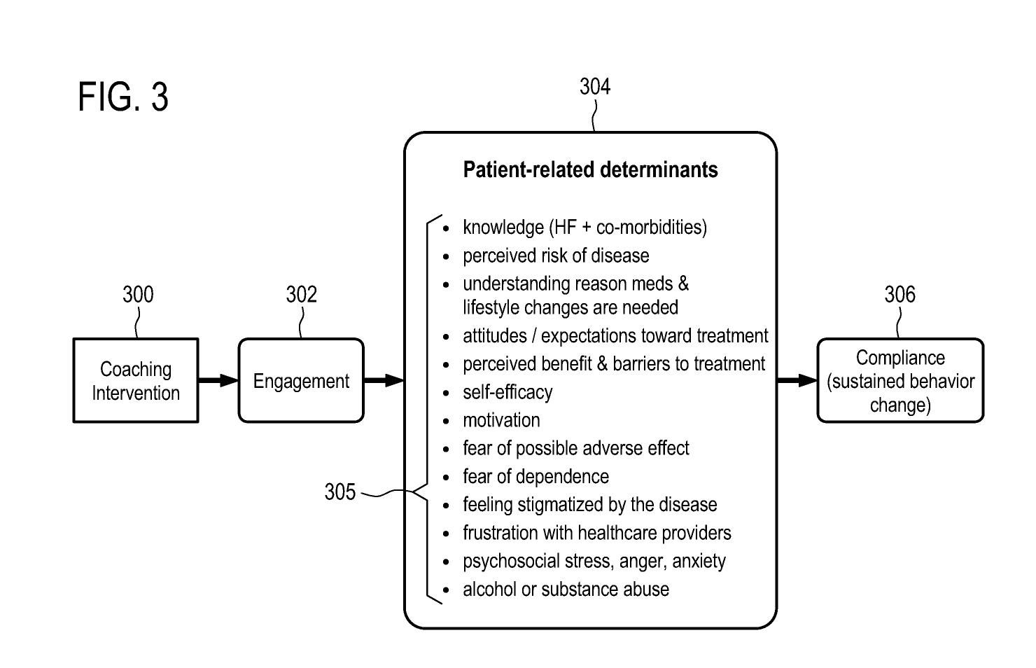

FIG. 3 illustrates an association between a coaching intervention and compliance mediated by patient engagement and the determinants of compliance. Step 300 is a coaching intervention. The coaching intervention 300 leads to compliance 306 which is a sustained behavior change in the patient. The compliance 306 is achieved by first engaging 302 the patient. Once engagement 302 has been achieved there are a number of determinants of compliance. Block 304 represents behavioral determinants of compliance. Within block 304 is a list 305 of possible determinants that may affect a patient's compliance 306.

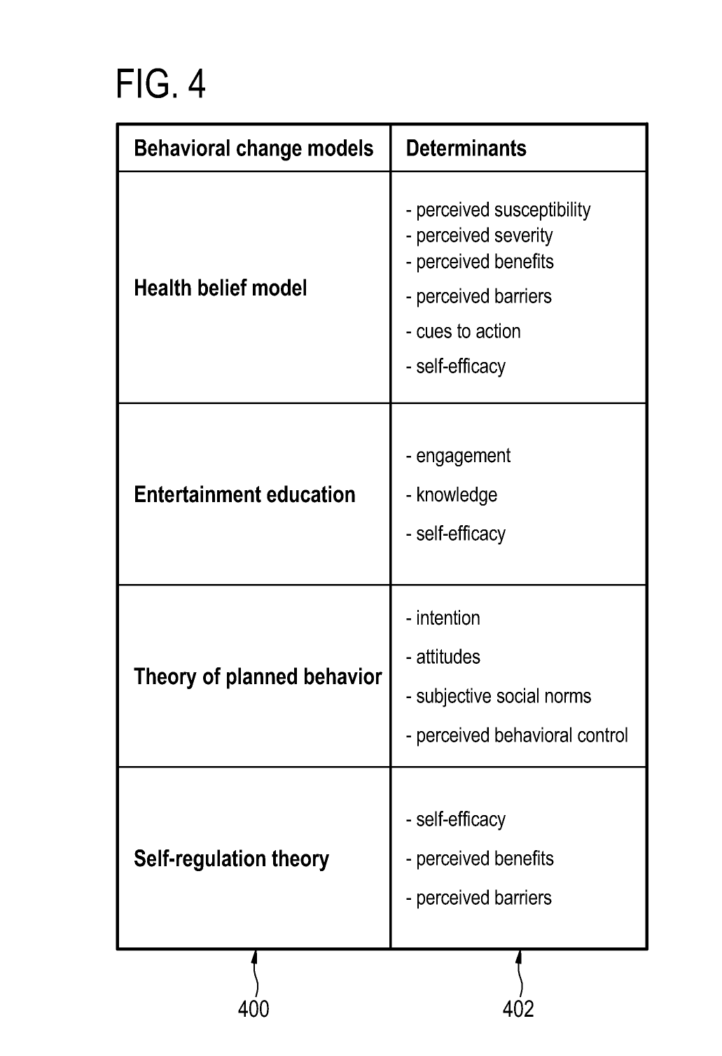

FIG. 4 shows a table of examples of behavioral models addressing specific behavioral determinants. In column 400 four different behavioral change models are listed. In column 402 determinants that are associated with that particular model are listed. During operation of the system a healthcare professional is presented with a list of determinants. By matching these selected determinants to the determinants in column 402 behavioral change models 400 which may be appropriate can be selected.

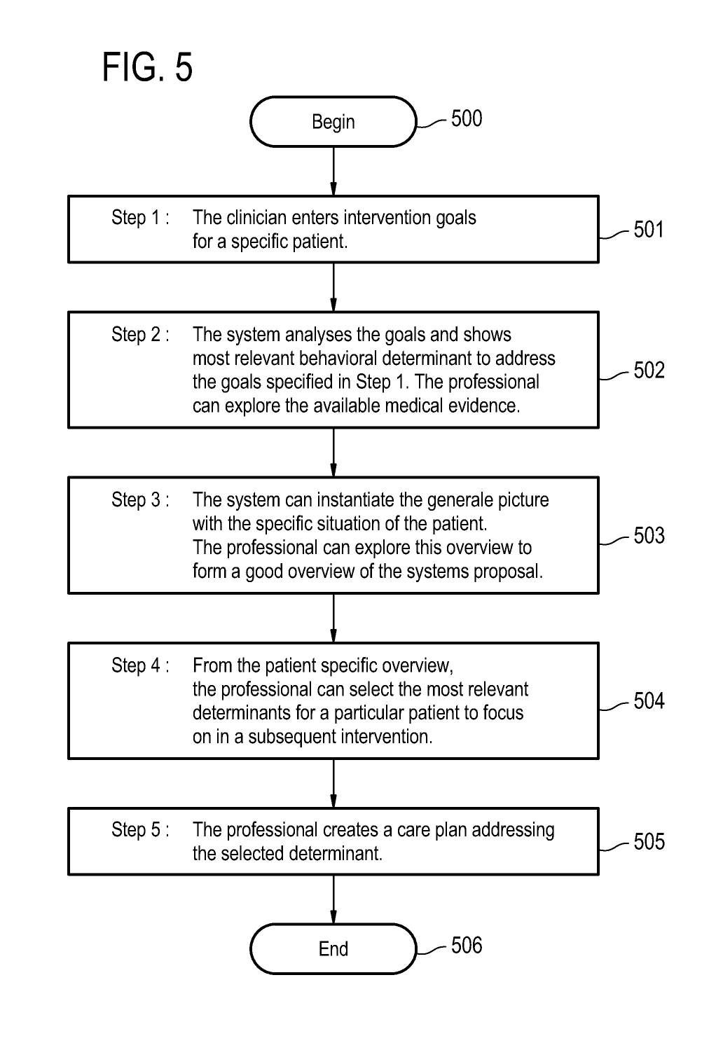

FIG. 5 shows a further embodiment of a method according to an embodiment of the invention. As with the method shown in FIGS. 1 and 2 the method shown in FIG. 5 may also be implemented as a computer-implemented method. The method shown in FIG. 5 could also be implemented by instructions on a computer-readable non-transitory storage medium. In step 500 the method begins. In step 501, which is also labeled step 1 in the text, the clinician enters intervention goals for a specific patient. In this example the intervention goal is explicitly entered by a healthcare professional. The intervention goal may be entered by a user interface for a computing system such as a graphical user interface or a keyboard.

In step 502, which is labeled in the text as step 2, the system analyzes the goal and shows the most relevant behavioral determinants to address the goals specified in step 1 also labeled step 501. In some embodiments the healthcare professional can explore the available medical evidence. In step 503, which is also labeled step 3 in the text, the system can instantiate the general picture with a specific situation of the patient. The healthcare professional can explore this overview to form a good overview of the system's proposal for a care plan.

In step 504, which is also labeled step 4 in the text, the healthcare professional can select from the patient specific overview the most relevant determinants for a particular patient to focus on in a subsequent intervention essentially to focus on during the use of a care plan. In step 505, which is also labeled step 5, the healthcare professional creates a care plan by having the clinical decision support system compile a care plan. Subsequently in step 506 the method ends.

In this embodiment, the healthcare professional first enters the intervention goals into the system (possibly by referring to the intervention goals for a specific patient). Second, the system responds with an overview of behavioral determinants that are relevant to address to the goals specified in Step 1.

These determinants may be ordered with respect to relevance for these specific goals, where the relevance is decided based on:

a. Evidence from literature; and/or

b. Historical information.

For example, relevance could be indicated by numbers in an ordered list, but the system could also provide more visual representations by e.g. relative sizes of bubbles or in the form of Tag Clouds.

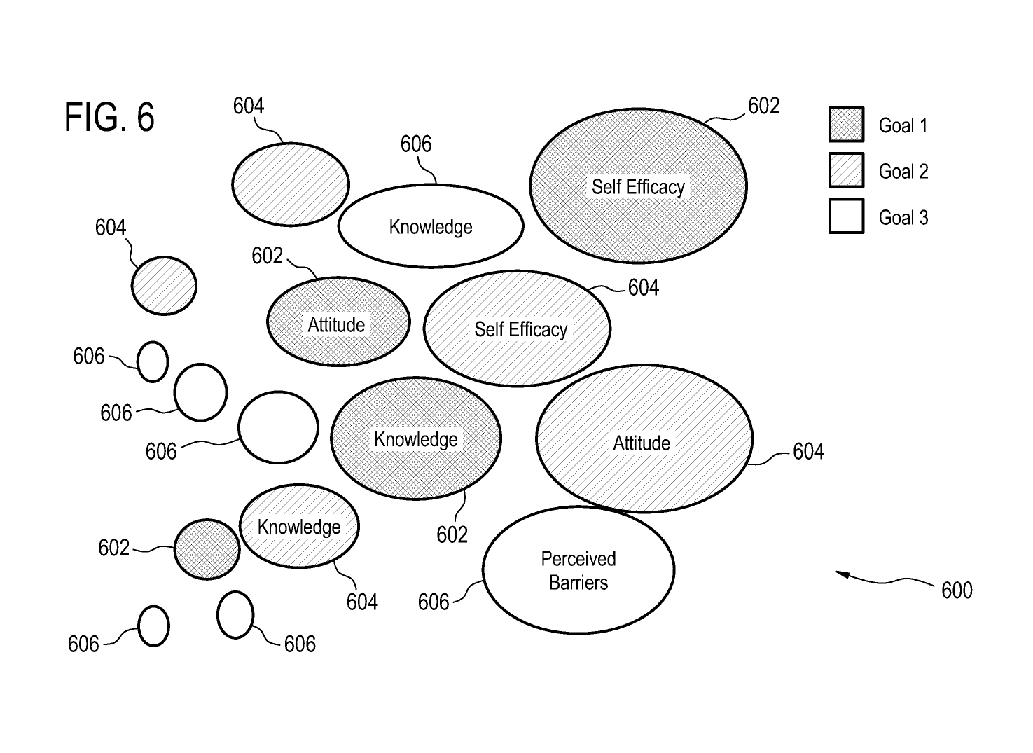

FIG. 6 shows a display 600 of the determinants 602, 604, 606 such as may be displayed on a graphical user interface to illustrate the relative importance of various determinants for addressing a particular intervention goal. In the determinants shown in FIG. 6 they are divided into three different groups. The determinants labeled 602 are determinants for intervention goal 1. The determinants labeled 604 are the determinants for intervention goal 2. The determinants labeled 606 are the determinants for intervention goal 3. The size of each determinant 602, 604, 606 shows the relative importance of each determinant towards achieving each intervention goal.

FIG. 6 shows the determinants (e.g., knowledge, self efficacy, attitude) that have been identified by the system as important for the indicated goals. The size of the bubbles indicates the relevance of the determinant: the bigger the bubble the more important is to address this determinant. Such structured presentation will help the professional to make more conscious choices on possible interventions to effect a behavioral change in the patient to increase compliance with the therapy.

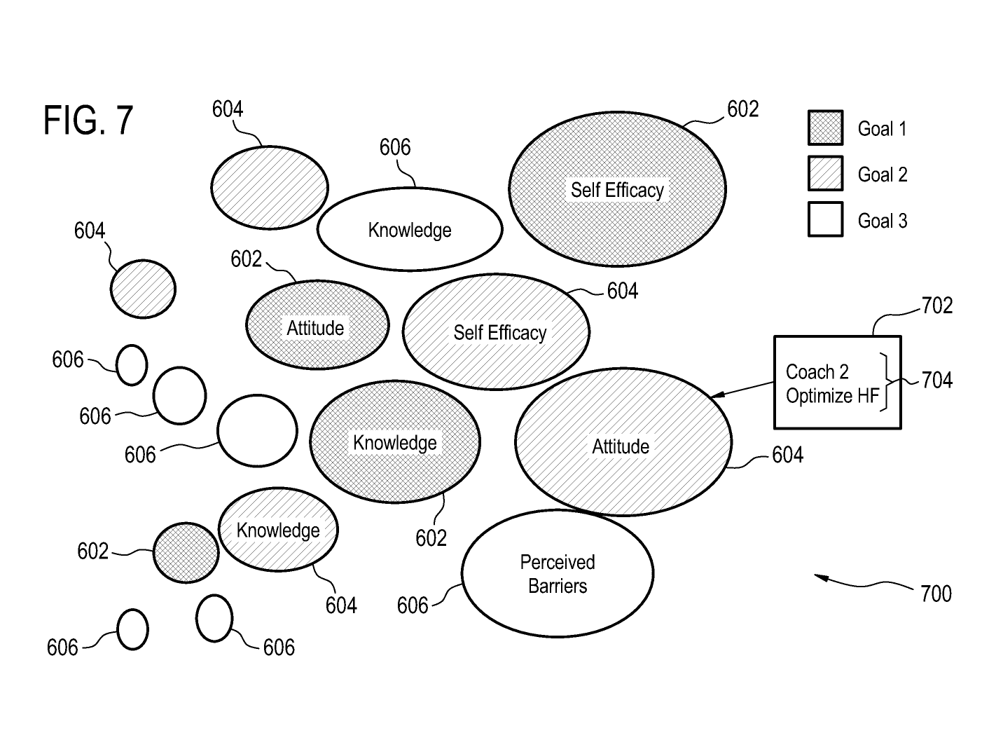

FIG. 7 shows the determinants 602, 604, 606 on a display 700. FIG. 7 illustrates how a graphical user interface with a display 700 may be used to display evidence relating to a particular determinant. Dialogue box 702 shows two items of evidence 704. In the example shown in FIG. 7 the dialogue box 702 simply has a list of available evidence 704. The healthcare professional can inspect either piece of this evidence by clicking on that evidence.

To get an insight on how the system came to the proposed set of determinants and their relative relevance, the care professional can select a determinant. The system then shows the evidence used, as indicated in FIG. 7. The user could then browse in more detail on how specific evidence contributes to that determinant and for which goal, and into that evidence to build his or her own opinion on the system's analyses.

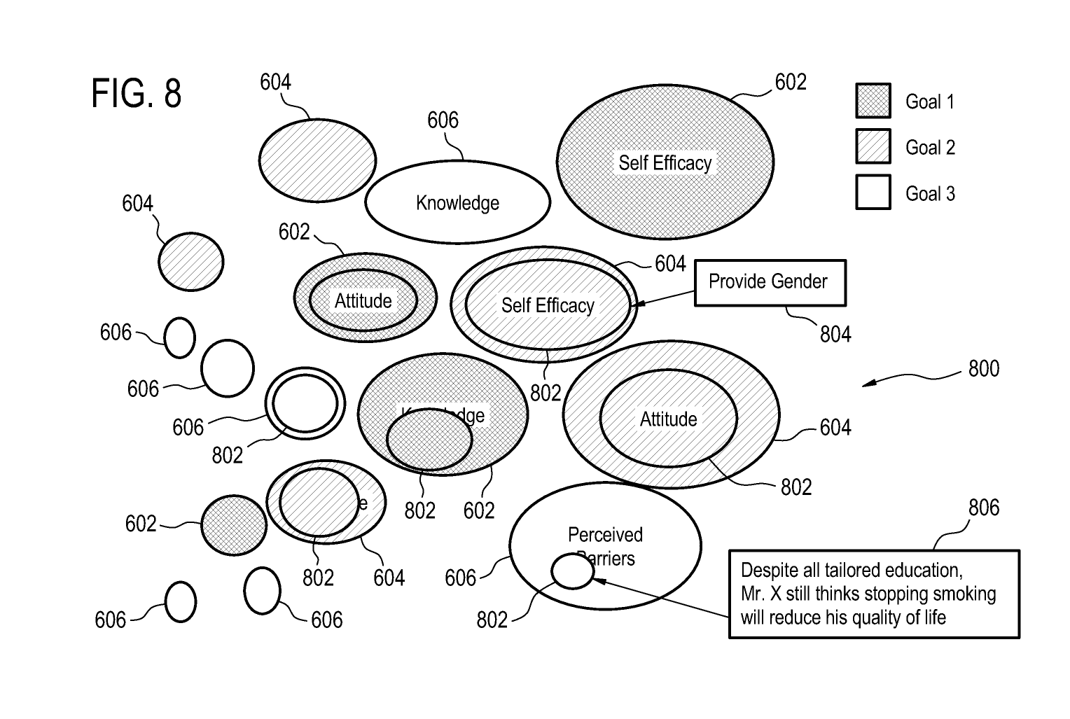

The previous analysis gave the importance of the determinant for general patient population from evidence. In the next step the professional can “instantiate” the determinants landscape for a specific patient, making the determinants' importance patient-specific. Namely, the actual situation of a patient is taken into account to re-evaluate the relevance for each determinant with respect to the identified goals. This results in an adapted picture of determinants for that specific patient in relation to the general population. An example is shown in FIG. 8, which depicts importance of the determinants for this patient.

FIG. 8 shows a display 800 of determinants 602, 604, 606 that are similar to the determinants shown in FIGS. 6 and 7. However, in FIG. 8 the boundary 802 of many of the determinants has been adjusted for a particular patient. For a given determinant the boundary 802 shows the new relative importance of the determinant for that particular patient. Several dialogue boxes 804, 806 are also shown in FIG. 8.

In FIG. 8 a smaller bubble represents the relevance of the particular determinant for the patient, while the bigger bubble represents the general population (in specific cases the personal bubble could also be bigger than the general one). It can also be indicated why the situation is different for this patient. The reasons for the differences between the general population and a patient specific are indicated such that the care professional gets can quickly make decision where to focus on.

The system could also indicate the determinants for which too little information is available to make a proper judgment what the effect is for a specific patient. E.g. in case there is evidence that “female patients with a high self-efficacy have high medication compliance” and the gender of the patient is not know (in the system), the system can trigger assessment of that aspect. Dialogue box 804 is a query to provide the gender of the patient as the gender is important to determining the self-efficacy of a particular patient. This can be done by asking the care professional to enter additional data into the Patient Information database, or to generate questionnaires that can be forwarded to the patient via e.g. Remote Patient Monitoring systems.

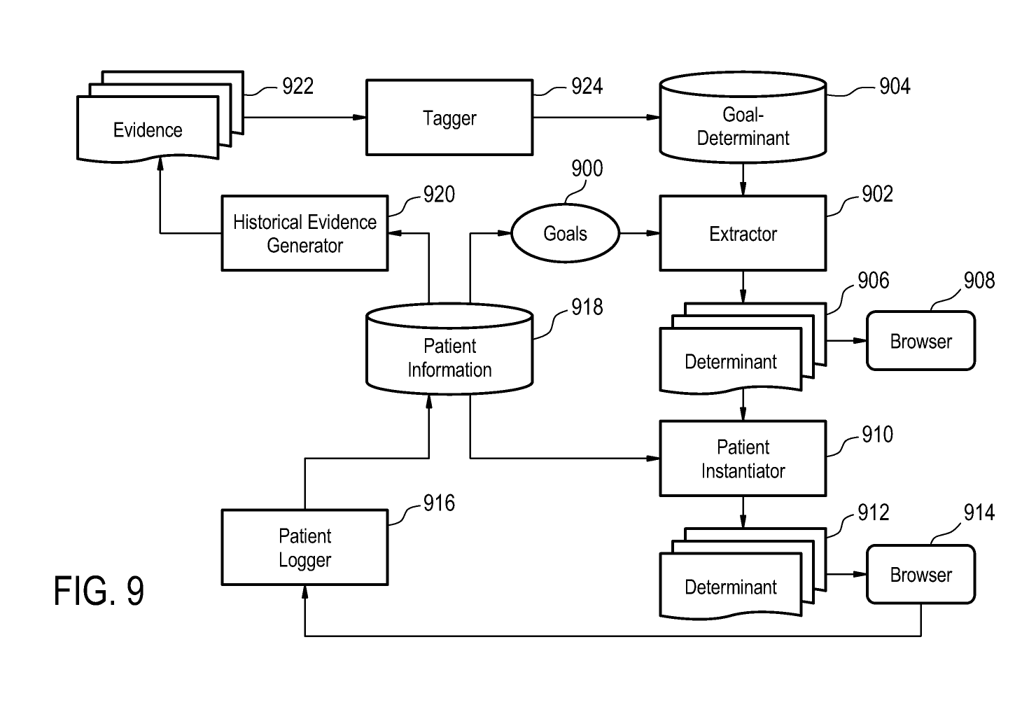

FIG. 9 shows a functional diagram of a clinical decision support system according to an embodiment of the invention. Block 900 represents an intervention goal or intervention goals being input into the system. It is understood that references to an intervention goal herein are also relevant to multiple intervention goals. This may represent either the automatic determination or by a manual input of an intervention goal. The intervention goal is input by block 900 into block 902. Block 902 is an extractor which queries a goal determinant database 904 for a list of determinants 906. The block 906 represents the list of determinants output by the extractor 902. The list of determinants 906 may be output to a browser window 908 or a graphical user interface, resulting in representations as indicated in FIGS. 6 and 7. A web browser display is an example of a graphical user interface.

A list of determinants 906 are then input into a patient instantiator 910. The patient instantiator reads patient data from a patient database 918. The patient instantiator then uses the patient data to output a modified set of determinants 912. The modified set of determinants 912 are then output to a browser 914 or other graphical user interface, resulting in representations as indicated in FIG. 8. The patient list of determinants 912 may then be used according to an embodiment of the invention to create a care plan. The data output by the browser 914 may also be output to a patient logger 916 which logs the list of modified determinants 912 in the patient information database 918. In some embodiments a patient logger 916 may be a remote patient management system. The data in the patient database 918 may be provided to block 900 as a trigger for automatically triggering the generation of an intervention goal. Data in the patient database 918 may also be data mined or statistically analyzed by a historical evidence generator 920.

The historical evidence generator 920 generates evidence 922 which is essentially the correlation between a particular intervention goal and the modified determinants 912. A tagging module 924 may then be used to enter the correlation between the evidence 922 and the modified determinants 912 into the goal determinant database 904. These new entries into the goal determinant database 904 may then be used by the extractor 902.

The system may comprise a Goal-Determinant database 904 storing abstract representations of Goals, Determinants, the effectual relation between them (indicating how important the determinant is for reaching the goal), maybe the sub-population for which these relation has been evaluated, and evidence for this relationship (in terms of scientific papers, evaluations of historical data) and the value of that evidence (contra, low, mid, high) with respect to that relationship.

The system may further comprise a database 918 storing patient information. This concerns information about the medical condition of the patient and other patient characteristics. It also concerns historical information about the therapy/intervention goals that have been prescribed, determinants that were addressed for reaching those goals; the determinants which have been assessed for that patient, and evaluation of the extent to which intervention goals were reached.

The system may further have an evidence tagger 924, a component in the system that evaluates evidence information, e.g. scientific papers and adds that to the Goal/Determinant database with all the information necessary to use it in the context of evaluating the relevance of the determinant with respect to the goal. This could be a manual process, where the system supports the entry of the required information by targeted input processes. Alternatively, this could be an ‘automated’ process where that system automatically analyses possible goal-determinant relations and the necessary information from published material. This could be a semi-automated process where the system first does autonomous analyses of the text and guides a nurse through the tagging process confirming relations found and/or asks for directed additions.

The system may further comprise an extractor 902. Given a set of goals, the extractor 902 retrieves from the Goal-Determinant database all relevant information to create the Determinant view. The extractor merges these sets of determinants into a single set of ranked determinants based on: relative relevance of the original goals from which the determinant was derived; relevance of the determinant in relation with the other determinants for the goal is was retrieved for; level of evidences related to that determinant; and based on the merged set, an overview picture of the determinants could be presented to the user as shown in FIG. 6 by a browser. This browser is also able to show the background information behind the determinants and ranking, such as the evidence.

The system may further comprise a Patient Instantiator 910. From the result of the Goal Extractor 902 and using information about the patient from the patient information database, the Patient Instantiator 910 evaluates:
1. whether the evidence actually holds for that patient. E.g., in case there is evidence that “female patients with a high self-efficacy have high medication compliance” (while similar evidence for male persons is not available), and the patient is male, the relevance of “self-efficacy” is calculated disregarding this specific evidence;
2. whether the determinant is satisfied for the patient, e.g. when self-efficacy is already very high for the patient, it becomes less important to focus any intervention on improving that determinant;
3. when significant effort has been focused on the determinant in the past, without any improvement, the determinants will become less relevant for that patient; and
4. merging/relating/rating the determinants in this way results in an advice to the care professional on which determinants to focus the therapy to have the highest probability of success.

Based on the merged set, an overview picture of the determinants could be presented to the user as shown in FIG. 8 by some kind of browser. This browser is also able to show the background information behind the determinants and ranking, like the evidence, relevant patient information, etc. The browser also allows the selection of determinant to select as a base for care plan creation. This selection is logged by the patient logger.

The systems may further comprise a Patient Logger 916 which gathers information about the patient and stores that in the patient information database. This is not only about medical information, but also the history of intervention goals set of a patient, the determinants selected to address these goals, the therapy selected based on these determinants, the effects of the therapy in terms of changes in the determinants for the patients and/or progression towards the goals set.

The system may further comprise a Historical Evidence Generator which analyses information stored in the Patient Information database with respect to relations between goals set and determinants selected. Output of this process could be used again as input for the total system for improving the whole process.

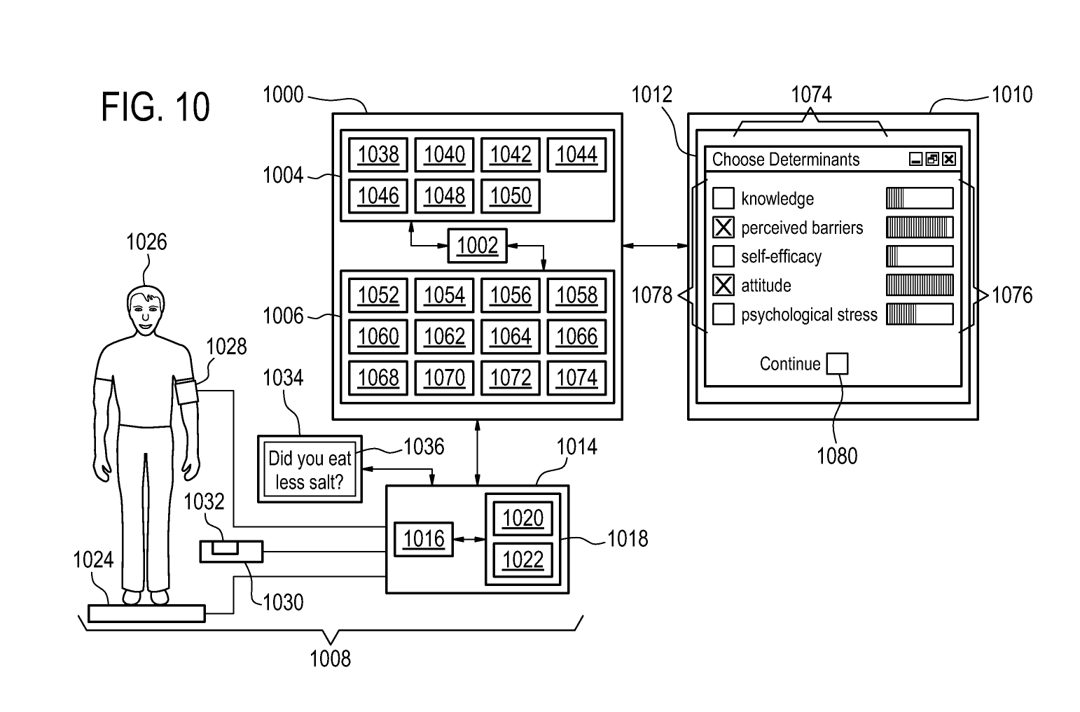

FIG. 10 shows a block diagram which illustrates the functionality of a clinical decision support system according to an embodiment of the invention. The clinical support decision system 1000 comprises a processor 1002, computer storage 1004 and computer memory 1006. Both the computer storage 1004 and the computer memory 1006 are examples of computer-readable non-transitory storage medium. The clinical support decision system is shown as being connected to a remote patient management system 1008. The clinical support decision system 1000 is also shown as being connected to a display 1010 which has a graphical user interface 1012.

The remote patient management system 1008 comprises an application hosting device 1014 which comprises a processor 1016 and a computer memory 1018. Stored within the computer memory 1018 is a care plan 1020 for execution by the application hosting device 1014 and remote patient management system data 1022. The remote patient management system data 1022 is data acquired by the application hosting device 1014 and which may be sent back to the clinical decision support system 1000 if it is queried. The remote patient management system also comprises in this example various diagnostic instruments 1024, 1028, 1032 for making physical measurements of vital signs on a patient 1026. In this example there is a scale 1024 for measuring the weight of the patient 1024, a blood pressure cuff 1028 for measuring the blood pressure of the patient 1026 and a urine test strip reader 1030 for measuring a urine sample 1032 from the patient 1026. All three of these diagnostic instruments 1024, 1028, 1032 are shown as being networked or connected to the application hosting device 1014. Also shown in this example is the application hosting device connected to a user interface 1034 or feedback device. The user interface 1034 in this example has a display 1036 which is currently displaying a survey. The response to the survey 1036 or measurements from the diagnostic instruments 1024, 1028, 1030 may each or in combination be used to generate the remote patient management system data 1022.

Within the memory within the computer storage 1004 is stored a care plan template database 1038 which contains care plans which may be selected using behavioral models. Also within the computer storage 1004 is a media library 1040 which may be linked to a care plan template during the compilation of a care plan. Also shown in the computer storage is a remote patient management system data 1042 which has been transmitted to the clinical support decision system 1000 by the application hosting device 1014. Also shown in the computer storage 1004 is a care plan 1044 which has been compiled by the clinical support decision system 1000.

The computer storage 1004 also contains a behavioral model database 1046, an evidence database 1048, and a medical record database 1050. The behavioral model database 1046 contains behavioral models which may be selected using behavioral determinants and the behavioral model is then used to select a care plan template from the care plan template database 1038. The evidence database 1048 contains correlations between patient information and determinants. This corresponds to the evidence 922 in FIG. 9. There is a medical record database 1050 which contains patient data 1052 about the patient 1026. The computer memory 1006 is shown as containing patient data 1052 extracted from the medical record database 1050.

The computer memory also contains a program module 1054 for executing instructions which implement an embodiment of the method according to the invention. The computer memory further contains a behavioral determinant list making module 1056 for generating the behavioral determinant list 1058 from a goal which has been input. The computer memory also contains a ranking module 1060 which are machine executable instructions for ranking the behavioral determinant list 1058 using the patient data 1052. The output of the ranking module 1060 is shown as a ranked behavioral determinant list 1062 which is also in the computer memory 1006. A subset of the behavioral determinant list 1064 which has been received is shown as being stored in the memory also 1006. Within the computer memory is also a care plan compilation module 1068 which contains machine executable instructions for compiling a care plan 1044 using the care plan template database 1038 and the media library 1040. Also within the computer memory is a historical evidence database generator 1070 which corresponds to the historical evidence generator 920 of FIG. 9. The computer memory also contains a tagger module 1072 which corresponds to the tagger 924 of FIG. 9.

The graphical user interface 1012 displays a list of behavioral determinants 1074. Adjacent to the list of behavioral determinants 1074 is a set of bar graphs 1076 which show the importance of each of the behavioral determinants 1074 to the patient 1026 that were determined using the patient data 1052. The graphical user interface 1012 then contains a set of check boxes 1078 adjacent to the list of behavioral determinants 1074 for selecting a subset of the list of behavioral determinants. Once the continue button 1018 on the graphical user interface 1012 is clicked by the healthcare professional the clinical support decision system 1000 receives the subset of the list of behavioral determinants.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### LIST OF REFERENCE NUMERALS

200 first item
300 second item
600 display of determinants
602 determinant for intervention goal 1
604 determinant for intervention goal 2
606 determinant for intervention goal 3
700 display of determinants
702 dialogue box showing evidence
704 evidence
800 display of determinants
802 adjusted size of determinant
804 dialogue box
806 dialogue box
900 intervention goal input
902 extractor
904 goal determinant database
906 list of determinants
908 browser window
910 patient instantiator
912 modified set of determinants
914 browser window
916 patient logger
918 patient information database
920 evidence generator
922 evidence
924 tagging module
1000 clinical support decision system
1002 processor
1004 computer storage
1006 computer memory
1008 remote patient management system
1010 display
1012 graphical user interface
1014 application hosting device
1016 processor
1018 computer memory
1020 care plan
1022 remote patient management system data
1024 scale
1026 patient
1028 blood pressure cuff
1030 urine test strip reader
1032 urine sample
1034 user interface or feedback device
1036 display with a survey
1038 care plan template database
1040 media library
1042 remote patient management system data
1044 care plan
1046 behavioral model database
1048 evidence database
1050 medical record database
1052 patient data
1054 program module
1056 behavioral determinant list making module
1058 behavioral determinant list
1060 ranking module
1062 ranked behavioral determinant list
1064 subset of behavioral determinant list
1066 list of selected behavioral models
1068 care plan compellation module
1070 historical evidence database generator
1072 tagger module
1074 list of behavioral determinants
1076 bar graphs showing adjusted importance
1078 check boxes
1080 continue button

What is claimed is:

1. A computer-implemented method for creating a care plan for a patient, the method comprising the steps of:
receiving an intervention goal;
creating a behavioral determinants list using the intervention goal;
assigning a ranking to each behavioral determinant in the list of behavioral determinates using patient data descriptive of the patient;
receiving a subset of the behavioral determinant list, wherein the subset is determined by using the ranking of each behavioral determinant in the list of behavioral determinates; and
creating the care plan using the subset.

2. The computer-implemented method of claim 1, wherein the care plan is created by:
generating a list of behavioral models using the subset of behavioral determinants;
receiving a selection of at least one selected behavioral model from the list of behavioral models; and
compiling the care plan using a care plan template determined by the at least one selected behavioral model.

3. The computer-implemented method of claim 1, wherein the method further comprises receiving remote patient management system data, wherein the step of receiving an intervention goal is performed by evaluating the remote patient management system data using a rule.

4. The computer-implemented method of claim 3, wherein the remote patient management system data comprises measurements of at least one vital sign from a patient.

5. The computer-implemented method of claim 3, wherein the remote patient management system data comprises responses to a questionnaire.

6. The computer-implemented method of claim 1, wherein the method further comprises the step of displaying the behavioral determinant list graphically on a display before receiving the subset, wherein the method further comprises displaying a graphical user interface at the same time as the behavioral determinant list which is adapted for triggering the display of medical evidence pertaining to each behavioral determinant.

7. The computer-implemented method of claim 1, wherein the method further comprises displaying the ranked subset of determinants graphically on a display, and wherein the subset is received from a graphical user interface of the display.

8. The computer-implemented method of claim 1, wherein the patient data at least partially comprises remote patient management system data, wherein the method further comprises requesting the remote patient management system data from a remote patient management system, and wherein the method further comprises receiving the value of the patient vital sign from the remote patient management system.

9. The computer-implemented method of claim 8, wherein the method further comprises:
determining the composition of remote patient management system data in order to reduce the length of the behavioral determinants list; and
reducing the length of the behavioral determinants list in accordance with the remote patient management system data.

10. A clinical decision support system comprising a processor and a computer-readable non-transitory storage medium, wherein the computer-readable non-transitory storage medium contains instructions that cause the processor to perform the steps of:
receiving an intervention goal;
creating a behavioral determinants list using the intervention goal;
assigning a ranking to each behavioral determinant in the list of behavioral determinates using patient data descriptive of the patient;
receiving a subset of the behavioral determinant list, wherein the subset is determined by using the ranking of each behavioral determinant in the list of behavioral determinates; and
creating the care plan using the subset.

11. The clinical decision support system of claim 10, wherein the care plan is created by:
generating a list of behavioral models using the group of behavioral determinants;
receiving a selection of at least one selected behavioral model from the list of behavioral models; and
compiling the care plan using a care plan template determined by the at least one selected behavioral model.

12. The clinical decision support system of claim 10, wherein the clinical decision support system further comprise a medical record database comprising at least a portion of the patient data, wherein the processor further performs the steps comprising
requesting the patient data from the medical record database; and
receiving the patient data from the medical record database.

13. The clinical decision support system of claim 12, wherein the clinical decision support system further comprises a historical evidence generator, wherein the historical evidence generator comprises computer executable code for statistically analyzing the medical record database for correlations between the intervention goal and behavioral determinants, wherein the clinical decision support system further comprises an evidence database, wherein the historical evidence generator further comprises computer executable code for entering correlations between the intervention goal and behavioral determinants into the evidence database, and wherein processor further performs the step comprising extracting the behavioral determinants list from the evidence database.

14. The clinical decision support system of claim 13, wherein the clinical decision support system comprises a tagger module comprising computer executable code for extracting correlations between intervention goals and behavioral determinants from publications.

15. The clinical decision support system of claim 14, wherein the tagger module uses natural language processing to extract the correlations between intervention goals and behavioral determinants from printed publications.

16. A computer-readable non-transitory storage medium containing instructions that when executed by a processor of a clinical decision support system cause the processor to perform the steps of:
receiving an intervention goal;
creating a behavioral determinants list using the intervention goal;
assigning a ranking to each behavioral determinant in the list of behavioral determinates using patient data descriptive of the patient;
receiving a subset of the behavioral determinant list, wherein the subset is determined by using the ranking of each behavioral determinant in the list of behavioral determinates; and
creating the care plan using the subset.

17. The computer-readable non-transitory storage medium of claim 16, wherein the care plan is created by:
generating a list of behavioral models using the group of behavioral determinants;
receiving a selection of at least one selected behavioral model from the list of behavioral models; and
compiling the care plan using a care plan template determined by the at least one selected behavioral model.

18. The computer-readable non-transitory storage medium of claim 16, wherein the instructions further cause the processor to perform the steps of:
receiving remote patient management system data; and
evaluating the remote patient management system data using a rule to generate an intervention goal.

19. The computer-readable non-transitory storage medium of claim 16, wherein the instructions further cause the processor to perform the steps of:
displaying the behavioral determinant list graphically on a display before receiving the subset; and
displaying a graphical user interface at the same time as the behavioral determinant list, wherein the graphical user interface is adapted for triggering the display of medical evidence pertaining to each behavioral determinant.

20. The computer-readable non-transitory storage medium of claim 16, wherein the instructions further cause the processor to perform the step of displaying the ranked subset of determinants graphically on a display, and wherein the subset is received from a graphical user interface of the display.
